(19) United States
(12) Patent Application Publication
(10) Pub. No.: US 2026/0176465 A1
(43) Pub. Date: Jun. 25, 2026

(54) ONE-COMPONENT STRUCTURAL ADHESIVE

(71) Applicant: 3M INNOVATIVE PROPERTIES COMPANY, St. Paul, MN (US)

(72) Inventors: Ling Jie Tong, Shanghai (CN); Jiaxing Sun, Shanghai (CN)

(21) Appl. No.: 19/126,875

(22) PCT Filed: Nov. 2, 2023
(86) PCT No.: PCT/IB2023/061076

§ 371 Date: May 2, 2025

(30) Foreign Application Priority Data
Nov. 4, 2022 (CN) 202211381878.5

(51) Int. Cl. C08L 63/00; C08G 59/62; C09J 11/06; C09J 133/08; C09J 163/00

(52) U.S. Cl. CPC C08L 63/00; C08G 59/621; C09J 11/06; C09J 133/08; C09J 163/00; C08L 2205/03

(57) ABSTRACT

Provided in the present invention is a one-component structural adhesive including: 47 to 61 weight percent of a first epoxy resin, the first epoxy resin having an epoxide equivalent weight of less than 240 grams per equivalent; 27 to 41 weight percent of a difunctional mercaptan; and 1 to 14 weight percent of a latent catalyst, wherein the total weight of the one-component structural adhesive is taken as 100 weight percent. The one-component structural adhesive according to the technical solution of the present invention can achieve fast curing at low temperatures, and the cured product thereof has high elongation-at-break and adhesion strength.

### TECHNICAL FIELD

The present invention relates to the technical field of structural adhesives, and in particular, the present invention provides a one-component structural adhesive which can achieve fast curing at low temperatures and a cured product of which has high elongation-at-break and adhesion strength.

### BACKGROUND ART

Commonly used epoxy adhesives include one-component (1K) adhesives and two-component (2K) adhesives. Compared to the two-component (2K) adhesives, the one-component (1K) adhesives are widely used in the fields of assembling mobile handheld devices, automotive industrial devices, electronic devices, and the like due to their ease of use. In addition, the one-component (1K) adhesives are typically more advantageous in industrial environments than the two-component (2K) adhesives, because the one-component (1K) adhesives typically exhibit better strength properties and corrosion resistance properties, and higher tolerance to surface defects and materials (e.g., manufacturing oils that may be present). However, in order to achieve sufficient curing, the one-component (1K) adhesives must usually be cured at elevated temperatures (e.g., over 100° C.) for a long period of time.

### SUMMARY

Therefore, it is of great significance to develop a one-component structural adhesive that can achieve fast curing at low temperatures.

In view of the technical problem described above, an objective of the present invention is to provide a one-component (1K) structural adhesive which can achieve fast curing at low temperatures, and the cured product of which has high elongation-at-break and adhesion strength.

The inventors have conducted intensive and detailed research to accomplish the present invention.

According to one aspect of the present invention, provided is a one-component structural adhesive comprising:
47-61 weight percent (wt %) of a first epoxy resin having an epoxide equivalent weight of less than 240 grams per equivalent (g/eq);
27-41 wt % of a difunctional mercaptan; and
1-14 wt % of a latent catalyst,
wherein the total weight of the one-component structural adhesive is taken as 100 wt %.

Compared to existing techniques in the art, the present invention has the following advantages: The one-component structural adhesive according to the technical solution of the present invention can achieve fast curing at a low temperature (about 65° C.) within a short period of time (about 30 minutes), and the cured product thereof has high elongation-at-break and adhesion strength.

### DETAILED DESCRIPTION

It should be appreciated that various other embodiments could be devised and modified by a person skilled in the art in light of the teachings of this description without departing from the scope or spirit of the present disclosure. Therefore, the following particular embodiments are not restrictive in meaning.

Unless otherwise indicated, all numbers used in this description and claims for the dimensions, quantities, and physicochemical properties of features should be construed to be modified by the term “approximately” in all instances. Accordingly, unless indicated to the contrary, the above numerical parameters listed in the description and attached claims are all approximations, which can be properly altered by a person skilled in the art using desired properties sought to be obtained from the teachings disclosed herein. The use of numerical ranges indicated by endpoints includes all numbers within that range and any range within that range, for example, 1 to 5 includes 1, 1.1, 1.3, 1.5, 2, 2.75, 3, 3.80, 4, and 5, etc.

Currently, one-component adhesives are widely used in the fields of assembling of mobile handheld devices, automotive industrial devices, electronic devices, and the like. In these industrial fields, there are scenarios in which the requirements on curing temperatures and curing speeds of adhesives are high. For example, the curing temperatures of the adhesives should be as low as possible to avoid causing deformation of adhered components. In addition, some specific components (e.g., mobile handheld devices, sports equipment, bicycles, stacked magnet parts, electronic devices, etc.) require portions to be adhered to have impact resistance, and thus the portions adhered by the cured adhesive must remain intact when the components are impacted or dropped. The inventors of the present invention have conducted intensive and detailed work and found that by specifically selecting components and contents of a one-component adhesive, a one-component structural adhesive that can achieve fast curing at low temperatures can be obtained, and a cured product thereof has high elongation-at-break and adhesion strength.

In particular, the present invention provides a one-component structural adhesive including:
47-61 wt % of a first epoxy resin having an epoxide equivalent weight of less than 240 g/eq;
27-41 wt % of a difunctional mercaptan; and
1-14 wt % of a latent catalyst,
wherein the total weight of the one-component structural adhesive is taken as 100 wt %.

The first epoxy resin that may be used in the present invention includes a wide variety of curable epoxy compounds and combinations thereof. The first epoxy resin that can be used includes liquids, solids, and mixtures thereof. In order to provide the cured product of the one-component structural adhesive which has high adhesion properties and impact resistance, an epoxide equivalent weight of the first epoxy resin needs to be controlled to be less than 240 g/eq. Preferably, the epoxide equivalent weight of the first epoxy resin is greater than or equal to 160 g/eq and less than 240 g/eq. Preferably, the epoxide equivalent weight of the first epoxy resin is greater than or equal to 160 g/eq and less than or equal to 190 g/eq. According to certain preferred embodiments of the present invention, the first epoxy resin is a difunctional epoxy resin. The term “difunctional epoxy resin” refers to an epoxy resin having two epoxy functional groups per molecule. Preferably, the first epoxy resin is a difunctional bisphenol A-type epoxy resin, a difunctional bisphenol F-type epoxy resin or a mixture thereof. Commercially available examples of the first epoxy resin that may be used in the present invention include: DER 331 (a difunctional bisphenol A-type epoxy resin having an epoxide equivalent weight of about 190 g/eq) produced by Olin Corporation, and WXDIC 830 (a difunctional bisphenol F-type epoxy resin having an epoxide equivalent weight of about 165 g/eq) produced by Nantong Xingchen Synthetic Material Co., Ltd. The one-component structural adhesive includes 47-61 wt % or more of the difunctional epoxy resin. Preferably, the one-component structural adhesive includes 52-61 wt % or more of the difunctional epoxy resin so as to achieve excellent adhesion properties and impact resistance at the same time.

In addition, the one-component structural adhesive according to the present invention may further include a second epoxy resin having an epoxide equivalent weight of greater than or equal to 240 g/eq. Preferably, the one-component structural adhesive further includes less than or equal to 10 wt % of the second epoxy resin having an epoxide equivalent weight of greater than or equal to 240 g/eq so as to provide excellent structural adhesive performance.

The one-component structural adhesive according to the present invention further includes a mercaptan compound as a component that reacts with the first epoxy resin (together with the second epoxy resin, if present) to achieve curing. The mercaptan compound is a low-functional mercaptan (e.g., a difunctional mercaptan and/or a trifunctional mercaptan). In the present invention, the term “difunctional mercaptan” refers to a mercaptan compound containing two mercaptan groups per molecule. Preferably, the difunctional mercaptan is ethylene glycol bis(3-mercaptopropionate). Commercially available examples of the difunctional mercaptan that may be used in the present invention include: Thiocure 320 (e.g., ethylene glycol bis(3-mercaptopropionate)) produced by Bruno Bock Chemische Fabrik GmbH & Co. Ltd, Germany. The one-component structural adhesive includes, based on the total weight thereof, 27-41 wt %, preferably 34-41 wt % of the difunctional mercaptan.

Furthermore, the one-component structural adhesive according to the present invention may further include a trifunctional mercaptan. The term “trifunctional mercaptan” refers to a mercaptan compound containing three mercaptan groups per molecule. In order to achieve the technical effect of some embodiments of the present invention, the one-component structural adhesive includes 12 wt % or less of the trifunctional mercaptan. Preferably, the one-component structural adhesive includes 3 wt % or less of the trifunctional mercaptan so as to achieve excellent adhesion properties and impact resistance at the same time. Preferably, the trifunctional mercaptan is trimethylolpropane tris(3-mercaptopropionate). Preferably, the one-component structural adhesive includes 4 wt % or less, preferably 2 wt % or less of a tetrafunctional mercaptan. More preferably, the one-component structural adhesive according to the present invention does not include a tetrafunctional mercaptan.

The one-component structural adhesive according to the present invention further includes a latent catalyst to catalyze a curing reaction between the first epoxy resin (together with the second epoxy resin, if present) and the difunctional mercaptan. Preferably, the latent catalyst is an amine latent catalyst. There is no particular limitation on the specific type of the latent catalyst that may be used in the present invention, as long as same can effectively catalyze the curing reaction between the epoxy resin and the difunctional mercaptan. Preferably, the amine latent catalyst is one or more selected from the group consisting of a modified cyclic fatty polyamine, a modified fatty polyamine and a modified amine adduct. Commercially available examples of the amine latent catalyst that may be used in the present invention include: FXR-1020 produced by T&K TOKA Co., Ltd, Japan, FXR-1081 produced by T&K TOKA Co., Ltd, Japan, and MY-25 produced by Ajinomoto Fine-Techno Co., Inc., Japan. The one-component structural adhesive includes 1-14 wt %, preferably 3-10 wt % of the latent catalyst.

Optionally, the one-component structural adhesive according to the present invention may further include a silane coupling agent that is used to improve the adhesion properties of the cured product of the structural adhesive. There is no particular limitation on the specific type of the silane coupling agent that may be used in the present invention, and the silane coupling agent can be appropriately selected from various silane coupling agents commonly used in structural adhesive applications in the art. Preferably, the silane coupling agent is or more one selected from the group consisting of Y-glycidyloxypropyltrimethoxysilane, 3-(2,3-epoxypropyloxy) propyltriethoxysilane, 3-(2,3-epoxypropyloxy) propylmethyldimethoxysilane, 3-(2,3-epoxypropyloxy) propylmethyldiethoxysilane, 3-mercaptopropyltrimethoxysilane, 3-mercaptopropyltriethoxysilane, bis(3-triethoxysilylpropyl) tetrasulfide, and bis(3-triethoxysilylpropyl) disulfide. Commercially available examples of the silane coupling agent that may be used in the present invention include KH-560 (i.e., γ-glycidyloxypropyltrimethoxysilane) produced by Sinopharm Chemical Reagent Co., Ltd.

In addition to the components mentioned above, the one-component structural adhesive according to the present invention may further include one or more other additives to impart or enhance one or more other properties of the structural adhesive. Specifically, these additives include calcium carbonate, kaolin, silica, aluminum hydroxide, aluminum oxide, aluminum nitride, diatomaceous earth, talc, toughening agent, and the like.

There is no particular limitation on specific preparation methods of the one-component structural adhesive described above. For example, the individual components included in the one-component structural adhesive can be mixed according to respective contents and stirred thoroughly.

Various exemplary embodiments of the present invention are further described by a list of embodiments below, which should not be construed as unduly limiting the present invention:

Particular Embodiment 1 is a one-component structural adhesive including:
47-61 wt % of a first epoxy resin having an epoxide equivalent weight of less than 240 g/eq;
27-41 wt % of a difunctional mercaptan; and
1-14 wt % of a latent catalyst,
wherein the total weight of the one-component structural adhesive is taken as 100 wt %.

Particular Embodiment 2 is the one-component structural adhesive according to Particular Embodiment 1, where the epoxide equivalent weight of the first epoxy resin is greater than or equal to 160 g/eq and less than 240 g/eq.

Particular Embodiment 3 is the one-component structural adhesive according to Particular Embodiment 1, where the epoxide equivalent weight of the first epoxy resin is greater than or equal to 160 g/eq and less than or equal to 190 g/eq.

Particular Embodiment 4 is the one-component structural adhesive according to Particular Embodiment 1, where the first epoxy resin is a difunctional epoxy resin.

Particular Embodiment 5 is the one-component structural adhesive according to Particular Embodiment 1, where the first epoxy resin is a difunctional bisphenol A-type epoxy resin, a difunctional 10 bisphenol F-type epoxy resin or a mixture thereof.

Particular Embodiment 6 is the one-component structural adhesive according to Particular Embodiment 1, where the one-component structural adhesive includes 52-61 wt % of the first epoxy resin.

Particular Embodiment 7 is the one-component structural adhesive according to Particular Embodiment 1, where the one-component structural adhesive further includes less than or equal to 10 wt % of a second epoxy resin having an epoxide equivalent weight of greater than or equal to 240 g/eq.

Particular Embodiment 8 is the one-component structural adhesive according to Particular Embodiment 1, where the difunctional mercaptan is ethylene glycol bis(3-mercaptopropionate).

Particular Embodiment 9 is the one-component structural adhesive according to Particular Embodiment 1, where the one-component structural adhesive includes 34-41 wt % of the difunctional 20 mercaptan.

Particular Embodiment 10 is the one-component structural adhesive according to Particular Embodiment 1, where the one-component structural adhesive further includes 12 wt % or less of a trifunctional mercaptan.

Particular Embodiment 11 is the one-component structural adhesive according to Particular Embodiment 1, where the one-component structural adhesive further includes 3 wt % or less of a trifunctional mercaptan.

Particular Embodiment 12 is the one-component structural adhesive according to Particular Embodiment 10 or 11, where the trifunctional mercaptan is trimethylolpropane tris(3-mercaptopropionate).

Particular Embodiment 13 is the one-component structural adhesive according to Particular Embodiment 1, where the latent catalyst is an amine latent catalyst.

Particular Embodiment 14 is the one-component structural adhesive according to Particular Embodiment 1, where an amine latent catalyst is one or more selected from the group consisting of a modified cyclic fatty polyamine, a modified fatty polyamine and a modified amine adduct.

Particular Embodiment 15 is the one-component structural adhesive according to Particular Embodiment 1, where the one-component structural adhesive further includes less than or equal to 2 wt % of a silane coupling agent.

Particular Embodiment 16 is the one-component structural adhesive according to Particular Embodiment 15, where the silane coupling agent is one or more selected from the group consisting of γ-glycidyloxypropyltrimethoxysilane, 3-(2,3-epoxypropyloxy) propyltriethoxysilane, 3-(2,3-epoxypropyloxy) propylmethyldimethoxysilane, 3-(2,3-epoxypropyloxy) propylmethyldiethoxysilane, 3-mercaptopropyltrimethoxysilane, 3-mercaptopropyltriethoxysilane, bis(3-triethoxysilylpropyl) tetrasulfide, and bis(3-triethoxysilylpropyl) disulfide.

The present invention will be described in more detail below with reference to examples. It should be pointed out that these descriptions and examples are for the purpose of facilitating the understanding of the present invention rather than limiting the present invention. The scope of protection of the present invention is subject to the appended claims.

### EXAMPLES

In the present invention, unless otherwise indicated, reagents which are used are all commercially available products, which are used directly without further purification.

TABLE 1
List of raw materials

| | | | Supplier or |
|---|---|---|---|
| Component | Chemical name | Product Name | Manufacturer |
| Epoxy resin | Difunctional bisphenol | DER 331 having an | Olin Corporation, |
| | A-type epoxy resin | epoxide equivalent | USA |
| | | weight of about | |
| | | 190 g/eq | |
| | Difunctional bisphenol | WXDIC 830 having an | Nantong Xingchen |
| | F-type epoxy resin | epoxide equivalent | Synthetic Material |
| | | weight of about | Co., Ltd |
| | | 165 g/eq | |
| | Difunctional bisphenol | SE-4125P having an | Shin-A T&C Co., |
| | A-type epoxy resin | epoxide equivalent | Ltd, Korea |
| | | weight of about | |
| | | 245 g/eq | |
| Mercaptan | Difunctional mercaptan | Thiocure 320 | Bruno Bock |
| | Ethylene glycol bis(3- | | Chemische Fabrik |
| | mercaptopropionate) | | GmbH & Co., Ltd, |
| | | | Germany |
| | Trifunctional mercaptan | Thiocure 330 | Bruno Bock |
| | Trimethylolpropane tris(3- | | Chemische Fabrik |
| | mercaptopropionate) | | GmbH & Co., Ltd, |
| | | | Germany |
| | Tetrafunctional mercaptan | Thiocure 340 | Bruno Bock |
| | Pentaerythritol tetra(3- | | Chemische Fabrik |
| | mercaptopropionate) | | GmbH & Co., Ltd, |
| | | | Germany |
| Latent | Amine latent catalyst | FXR-1020 | T&K TOKA Co., Ltd., |
| catalyst | | | Japan |
| | Amine latent catalyst | FXR-1081 | T&K TOKA Co., Ltd., |
| | | | Japan |
| | Amine latent catalyst | MY-25 | Ajinomoto Fine- |
| | | | Techno Co., Inc., |
| | | | Japan |
| Silane | γ- | KH-560 | Sinopharm Chemical |
| coupling | glycidyloxypropyl- | | Reagent Co., Ltd. |
| agent | trimethoxysilane | | |

### Test Methods

### Tests on the Adhesion Properties (Lap Shear Strength) and Elongation-at-Break Properties of a Cured Product of the One-Component Structural Adhesive

### Elongation-at-Break

The elongation-at-break was measured according to ASTM D638 by using an Instron 5969 tensile tester manufactured by Instron Corporation, US. Specifically, the one-component structural adhesives prepared in the following examples and comparative examples were pressed into dog-bone-shaped samples with a thickness of 3 millimeters (mm). The samples were cured at 65° C. for 30 minutes (min) to obtain specimens. Then the specimens were subjected to tensile testing at a tensile speed of 50 mm/min by using the Instron 5969 tensile tester. The obtained elongation-at-break (%) results are shown in Table 2 below.

If the elongation-at-break (%) of the cured product is greater than or equal to 500%, the one-component structural adhesive is considered to meet the basic requirements for impact resistances of specific components (e.g., mobile handheld devices, sports equipment, bicycles, stacked magnet parts, electronic devices, etc.), useful for some applications; and if the elongation-at-break (%) of the cured product is greater than or equal to 700%, the one-component structural adhesive is considered to have excellent impact resistance.

### Adhesion Properties

Specifically, two aluminum plates (etched aluminum 2024T3) having dimensions of 101.6 mm (length)×25.4 mm (width)×2 mm (thickness), produced by Changcheng Printing Co., Ltd in Kunshan, Jiangsu, were taken, and the surfaces of the two aluminum plates were wiped clean with isopropyl alcohol and air-dried at room temperature. The two etched aluminum 2024T3 plates overlap with each other by 25.4 mm (width)×12.7 mm (length) at respective ends thereof, where 0.2 gram (g) of a uniformly distributed liquid one-component structural adhesive prepared in the following examples and comparative examples was held between the overlapping areas of the two etched aluminum 2024T3 plates. Then, the etched aluminum 2024T3 plates connected by the adhesive were baked in an oven at a temperature of 65° C. for 30 minutes and then placed at room temperature for 2 hours. The adhesion properties (lap shear strength) (unit: megapascal (MPa)) was tested at room temperature (22-24° C.) at a tensile speed of 2.54 mm/min according to the dynamic shear test standard ASTM D1002-72 by using the Instron 5969 device produced by Instron Corporation, USA. The obtained lap shear strength results (unit: MPa) are shown in Table 2 below.

If the lap shear strength of the cured product on the aluminum plates is greater than or equal to 5 MPa, the one-component structural adhesive is considered to meet basic requirements for adhesion properties; and if the lap shear strength of the cured product on the aluminum plates is greater than or equal to 9 MPa, the one-component structural adhesive is considered to have excellent adhesion properties.

### Example 1 (E1)

58 g of a difunctional bisphenol A-type epoxy resin DER 331, 39 g of a difunctional mercaptan Thiocure 320 and 3 g of an amine latent catalyst FXR-1081 were added into a vessel, and then sequentially stirred manually for 2 minutes, stirred by using a THINKY mixer for 5 minutes at 500 revolutions per minute, stirred manually for 2 minutes, and then again stirred by using the THINKY mixer for 5 minutes at 500 revolutions per minute to obtain a one-component structural adhesive 1.

According to the adhesion property (lap shear strength) and elongation-at-break property test methods described in detail above, a test on the adhesion properties (lap shear strength) and elongation-at-break properties of the obtained one-component structural adhesive 1 was performed, and the results are shown in Table 2 below.

### Examples 2-13 (E2-E13) and Comparative Examples 1-7 (CE1-CE7)

In Examples 2-13 (E2-E13) and Comparative Examples 1-7 (CE1-CE7), operations were performed in a similar manner as in Example 1, except that the types of each component and the content thereof are varied only as shown in Table 2 below to obtain one-component structural adhesives 2-13 and comparative one-component structural adhesives 1-7.

According to the adhesion property (lap shear strength) and elongation-at-break property test methods described in detail above, tests on the adhesion properties (lap shear strengths) and elongation-at-break properties of the obtained one-component structural adhesives 2-13 and the obtained comparative one-component structural adhesives 1-7 were performed, and the results are shown in Table 2 below.

TABLE 2
Compositions of the one-component structural adhesives prepared in Examples 1-13
(E1-E13) and Comparative Examples 1-7 (CE1-CE7) and property test results thereof

| Composition | | E1 | E2 | E3 | E4 | E5 | E6 | E7 | E8 | E9 | E10 | E11 | E12 |
|---|---|---|---|---|---|---|---|---|---|---|---|---|---|
| Epoxy | DER 331 | 58 | 61 | 52 | | | | 47 | 52 | 52 | 58 | 58 | 58 |
| resin | WXDIC | | | | 61 | 58 | 56 | | | | | | |
| | 830 | | | | | | | | | | | | |
| | SE-4125P | | | | | | | 10 | 6 | 6 | | | |
| Mercaptan | Thiocure | 39 | 36 | 34 | 38 | 39 | 41 | 36 | 27 | 30 | 33 | 35 | 35 |
| | 320 | | | | | | | | | | | | |
| | Thiocure | | | | | | | | 12 | 9 | 6 | 4 | 4 |
| | 330 | | | | | | | | | | | | |
| | Thiocure | | | | | | | | | | | | |
| | 340 | | | | | | | | | | | | |
| Latent | MY-25 | | | | | | | | 3 | | | | |
| catalyst | FXR-1020 | | | | | | | | | 3 | | | |
| | FXR-1081 | 3 | 3 | 14 | 1 | 3 | 3 | 5 | | | 3 | 3 | 2 |
| Silane | KH-560 | | | | | | | 2 | | | | | 1 |
| coupling | | | | | | | | | | | | | |
| agent | | | | | | | | | | | | | |

| | | | | | | | | | | | | |
|---|---|---|---|---|---|---|---|---|---|---|---|---|
| Total | 100 | 100 | 100 | 100 | 100 | 100 | 100 | 100 | 100 | 100 | 100 | 100 |

Property test results

| | | | | | | | | | | | | |
|---|---|---|---|---|---|---|---|---|---|---|---|---|
| Lap shear strength | 9.2 | 10.3 | 9.6 | 10.7 | 10.6 | 9.6 | 5.2 | 6.6 | 5.2 | 10.3 | 10.0 | 11.5 |
| (MPa) | | | | | | | | | | | | |
| Elongation-at-break | 765 | 728 | 719 | 702 | 716 | 760 | 1273 | 517 | 597 | 581 | 646 | 646 |
| (%) | | | | | | | | | | | | |

| Composition | | E13 | CE1 | CE2 | CE3 | CE4 | CE5 | CE6 | CE7 |
|---|---|---|---|---|---|---|---|---|---|
| Epoxy | DER 331 | 58 | 45 | 52 | 52 | 46 | 62 | 71 | 55 |
| resin | WXDIC | | | | | | | | |
| | 830 | | | | | | | | |
| | SE-4125P | | 12 | 6 | | | | | |
| Mercaptan | Thiocure | 36 | 36 | 24 | 32 | 50 | 35 | 26 | 42 |
| | 320 | | | | | | | | |
| | Thiocure | 3 | | 15 | | | | | |
| | 330 | | | | | | | | |
| | Thiocure | | | | 2 | | | | |
| | 340 | | | | | | | | |
| Latent | MY-25 | | | 3 | | | | | |
| catalyst | FXR-1020 | | | | | | | | |
| | FXR-1081 | 3 | 5 | | 14 | 3 | 3 | 3 | 3 |
| Silane | KH-560 | | 2 | | | | | | |
| coupling | | | | | | | | | |
| agent | | | | | | | | | |

| Total | 100 | 100 | 100 | 100 | 100 | 100 | 100 | 100 |
|---|---|---|---|---|---|---|---|---|
| Property test results | | | | | | | | |
| Lap shear strength | 9.7 | 3.8 | 7.1 | 7.7 | 0.1 | 4.5 | 0.5 | 1.5 |
| (MPa) | | | | | | | | |
| Elongation-at-break | 705 | 1680 | 420 | 486 | Unmea- | 530 | Unmea- | 1730 |
| (%) | | | | | surable | | surable | |

As can be seen from the results shown in Table 2 above, when individual components and contents thereof in structural adhesives are specifically selected within the scope of the present invention, a one-component structural adhesive that can achieve fast curing (curing time: about 30 minutes) at low temperatures (as low as 65° C.) can be obtained, and the cured product thereof has high elongation-at-break (i.e., an elongation-at-break greater than or equal to 500%) and adhesion strength (a lap shear strength greater than or equal to 5 MPa).

As can be seen from the results of Examples 1-6 in Table 2, when a structural adhesive includes 52-61 wt % of a first epoxy resin having an epoxide equivalent weight of less than 240 g/eq (i.e., a difunctional bisphenol A-type epoxy having an epoxide equivalent weight of about 190 g/eq or a difunctional bisphenol F-type epoxy having an epoxide equivalent weight of about 165 g/eq) and 34-41 wt % of a difunctional mercaptan (i.e., ethylene glycol bis(3-mercaptopropionate)), the obtained one-component structural adhesive can achieve both excellent elongation-at-break (i.e., an elongation-at-break greater than or equal to 700%) and excellent adhesion strength (i.e., a lap shear strength greater than or equal to 9 MPa).

As can be seen from the comparison of the results of Comparative Example 1 and Example 7, when the structural adhesive includes more than 10 wt % of a second epoxy resin having an epoxide equivalent weight of greater than 240 g/eq (i.e., a difunctional bisphenol A-type epoxy resin having an epoxide equivalent weight of about 245 g/eq), although the elongation-at-break of the cured product of the obtained one-component structural adhesive increases, the adhesion properties are greatly reduced (the lap shear strength is 3.8 MPa in Comparative Example 1), so that the one-component structural adhesive cannot satisfy the basic requirements for adhesion of specific components, useful for some applications.

As can be seen from the comparison of the results of Comparative Example 2 and Example 8, when the structural adhesive includes more than 12 wt % of a trifunctional mercaptan (i.e., trimethylolpropane tris(3-mercaptopropionate)), the elongation-at-break of the cured product of the obtained one-component structural adhesive is greatly reduced (the elongation-at-break is 420% in Comparative Example 2), so that the one-component structural adhesive cannot satisfy the basic requirements for impact resistance of specific components (e.g., mobile handheld devices, sports equipment, bicycles, stacked magnet parts, electronic devices, etc.), useful for some applications.

As can be seen from the comparison of the results of Comparative Example 3 and Example 3, when the structural adhesive includes more than 2 wt % of a tetrafunctional mercaptan (i.e., pentaerythritol tetra(3-mercaptopropionate)), the elongation-at-break and the lap shear strength of the cured product of the obtained one-component structural adhesive are both greatly reduced, in particular, the elongation-at-break is reduced to 486%, so that the one-component structural adhesive cannot satisfy the basic requirements for impact resistance of specific components (e.g., mobile handheld devices, sports equipment, bicycles, stacked magnet parts, electronic devices, etc.), useful for some applications.

As can be seen from the comparison of the results of Comparative Examples 4-7 and Examples 1-3, when the contents of the first epoxy resin and/or the difunctional mercaptan are adjusted beyond the scope of the present invention, both the elongation-at-break and adhesion properties cannot meet the basic requirements.

Although the above particular embodiments comprise many specific details for the purpose of illustration, those skilled in the art should understand that many variations, modifications, replacements and changes to these details all fall within the scope of the present invention as claimed in the claims. Therefore, the disclosure as described in the specific embodiments does not pose any limitation to the present invention as claimed in the claims. The proper scope of the present invention should be defined by the claims and proper legal equivalents thereof. All references referred to are incorporated herein by reference in their entireties.

What is claimed is:

1. A one-component structural adhesive, comprising:
47 to 61 weight percent of a first epoxy resin having an epoxide equivalent weight of less than 240 grams per equivalent;
27 to 41 weight percent of a difunctional mercaptan; and
1 to 14 weight percent of a latent catalyst,
wherein the total weight of the one-component structural adhesive is taken as 100 weight percent.

2. The one-component structural adhesive according to claim 1, wherein the epoxide equivalent weight of the first epoxy resin is greater than or equal to 160 grams per equivalent and less than 240 grams per equivalent.

3. The one-component structural adhesive according to claim 1, wherein the epoxide equivalent weight of the first epoxy resin is greater than or equal to 160 grams per equivalent and less than or equal to 190 grams per equivalent.

4. The one-component structural adhesive according to claim 1, wherein the first epoxy resin is a difunctional epoxy resin.

5. The one-component structural adhesive according to claim 1, wherein the first epoxy resin is a difunctional bisphenol A-type epoxy resin, a difunctional bisphenol F-type epoxy resin, or a mixture thereof.

6. The one-component structural adhesive according to claim 1, wherein the one-component structural adhesive comprises 52 to 61 weight percent of the first epoxy resin.

7. The one-component structural adhesive according to claim 1, wherein the one-component structural adhesive further comprises less than or equal to 10 weight percent of a second epoxy resin having an epoxide equivalent weight of greater than or equal to 240 grams per equivalent.

8. The one-component structural adhesive according to claim 1, wherein the difunctional mercaptan is ethylene glycol bis(3-mercaptopropionate).

9. The one-component structural adhesive according to claim 1, wherein the one-component structural adhesive comprises 34 to 41 weight percent of the difunctional mercaptan.

10. The one-component structural adhesive according to claim 1, wherein the one-component structural adhesive further comprises 12 weight percent or less of a trifunctional mercaptan.

11. The one-component structural adhesive according to claim 1, wherein the one-component structural adhesive further comprises 3 weight percent or less of a trifunctional mercaptan.

12. The one-component structural adhesive according to claim 10, wherein the trifunctional mercaptan is trimethylolpropane tris(3-mercaptopropionate).

13. The one-component structural adhesive according to claim 1, wherein the latent catalyst is an amine latent catalyst.

14. The one-component structural adhesive according to claim 13, wherein the amine latent catalyst is one or more selected from the group consisting of a modified cyclic fatty polyamine, a modified fatty polyamine and a modified amine adduct.

15. The one-component structural adhesive according to claim 1, wherein the one-component structural adhesive further comprises less than or equal to 2 weight percent of a silane coupling agent.

16. The one-component structural adhesive according to claim 15, wherein the silane coupling agent is one or more selected from the group consisting of γ-glycidyloxypropyltrimethoxysilane, 3-(2,3-epoxypropyloxy) propyltriethoxysilane, 3-(2,3-epoxypropyloxy)propylmethyldimethoxysilane, 3-(2,3-epoxypropyloxy) propylmethyldiethoxysilane, 3-mercaptopropyltrimethoxysilane, 3-mercaptopropyltriethoxysilane, bis(3-triethoxysilylpropyl) tetrasulfide, and bis(3-triethoxysilylpropyl) disulfide.
